(19) United States
(12) Patent Application Publication
(10) Pub. No.: US 2023/0339667 A1
(43) Pub. Date: Oct. 26, 2023

(54) Blu Max Treats Device

(71) Applicant: Eunice Marchman, Chicago, IL (US)

(72) Inventor: Eunice Marchman, Chicago, IL (US)

(21) Appl. No.: 18/303,776

(22) Filed: Apr. 20, 2023

Related U.S. Application Data
(60) Provisional application No. 63/333,176, filed on Apr. 21, 2022.

(51) Int. Cl. B65D 81/34; A23K 10/30; A23K 50/40

(52) U.S. Cl. CPC B65D 81/34; A23K 10/30; A23K 50/40; B65D 2581/3428

(57) ABSTRACT

The present invention relates to a novel pet treat system. The system comprises a special, pre-mixed dough made from a pet treat recipe. The recipe comprises at least flour, eggs, canned pumpkin, peanut butter, salt, cinnamon, and water, and can also comprise additional ingredients for making various flavored pet treats. Typically, the pre-mixed dough is formed into individual pet shapes and stored within a packaging component. The packaging component comprises a disposable oven-safe and microwave-safe tray that the pre-mixed dough is positioned on. Thus, allowing pet owners to bake the pet treats without needing to mix their own ingredients. Further, the packaging component is resealable to allow for the unbaked treats to remain fresh.

### CROSS-REFERENCE TO RELATED APPLICATION

The present application claims priority to, and the benefit of, U.S. Provisional Application No. 63/333,176, which was filed on Apr. 21, 2022, and is incorporated herein by reference in its entirety.

### FIELD OF THE INVENTION

The present invention relates generally to the field of pet treats. More specifically, the present invention relates to an improved pet treat system that provides users with a pre-packaged pet treat which a user then bakes to make healthy, ready-to-eat treats for their pets. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in pet treats. Pet owners may not know what types of ingredients are included in pet treats currently available in stores. Further, pet owners may want to make their own pet treats but may not know how or what kinds of ingredients to implement. Thus, the pet treat system saves time and money and is convenient and mess-free. Further, the disclosed system reduces the hassle of buying and/or mixing the ingredients together. Rather, the system allows a user to bake and go.

Accordingly, it is necessary for users to have a pet treat system that provides pre-mixed pet treats that a user can place directly in an oven to bake. Further, the pre-mixed pet treats need to be made from a simple recipe with fresh ingredients, such that the pre-mixed pet treats are healthy for a pet to eat. Additionally, the pet treats need to be convenient to make and should allow a user to utilize either a microwave or oven to bake the treats.

Therefore, there exists a long-felt need in the art for a pet treat system that provides users with a pre-packaged pet treat which a user then bakes to make healthy, ready-to-eat treats for their pets. There is also a long-felt need in the art for a pet treat system that includes multiple different-sized treats, allowing pet owners to serve their pets a desired type of treat. Further, there is a long-felt need in the art for a pet treat system that features microwave and oven-safe trays for the pet treats, these trays are then used to bake the pre-made treats at home. Moreover, there is a long-felt need in the art for a system that utilizes resealable packaging to maintain the freshness of the treats for future feedings. Further, there is a long-felt need in the art for a pet treat system that offers multiple different sized treats, allowing pet owners to serve their pets a desired type and size of treat. Finally, there is a long-felt need in the art for a pet treat system that allows users to be able to bake pet treats without mixing their own ingredients.

The subject matter disclosed and claimed herein, in one embodiment thereof, comprises a pet treat system. The system is a pet product for various types of pets. The system comprises a special, pre-mixed dough made from a pet treat recipe. The recipe comprises at least flour, eggs, canned pumpkin, peanut butter, salt, cinnamon, and water, and can also comprise additional ingredients for making various flavored pet treats. Typically, the pre-mixed dough is formed into individual pet shapes and stored within a packaging component. The packaging component comprises a disposable oven-safe and microwave-safe tray that the pre-mixed dough is positioned on. Thus, allowing pet owners to bake the pet treats without mixing their own ingredients. Further, the packaging component is resealable to allow for the unbaked treats to remain fresh. Additionally, the system can comprise various sizes of pet treats, such as small, medium, and large sized treats.

In this manner, the pet treat system of the present invention accomplishes all of the foregoing objectives and provides users with a system that provides pre-packaged pet treats for their pets. The device provides users with a way to conveniently and easily make healthy pet treats for their pets. The device offers pet treats of various sizes, varieties and flavors depending on a pet's wants or needs.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a pet treat system. The system is a pet product for various types of pets. The system comprises a special, pre-mixed dough made from a pet treat recipe. The recipe comprises at least flour, eggs, canned pumpkin, peanut butter, salt, cinnamon, and water, and can also comprise additional ingredients for making various flavored pet treats. Typically, the pre-mixed dough is formed into individual pet shapes and stored within a packaging component. The packaging component comprises a disposable oven-safe and microwave-safe tray component that the pre-mixed dough is positioned on. Thus, allowing pet owners to bake the pet treats without mixing their own ingredients.

In one embodiment, the pet treat system comprises a special, pre-mixed dough secured within a packaging component. The special, pre-mixed dough is a ready-for-use refrigerated dough for preparing pet treats. Typically, the dough is prepared from flour, eggs, canned pumpkin, peanut butter, salt, cinnamon, and water. Additional ingredients can be incorporated based on the needs and/or wants of a pet, such as based on the medications, weight problems, eating issues, or other diseases or health issues the pet may have. The pre-mixed dough is typically provided in a block form or separate, defined pieces of dough. The dough is then placed in a microwave or oven and baked into pet treats for use.

In the present description, the contents are given by weight. For example, the flour is present in an amount of 57%, the eggs in an amount of 18%, the canned pumpkin in an amount of 19%, the peanut butter in an amount of 4.5%, the salt in an amount of 0.5%, the ground cinnamon in an amount of 0.5%, and optional water in an amount of 0.8%.

The flour used is typically wholewheat flour which gives the baked products a denser and heavier texture. However, any type of flour can be utilized as is known in the art depending on the wants and/or needs of a user. The flour content is normally between about 50% and 60%, preferably between 55% and 57%.

In one embodiment, the dough should have a good resistance during preservation in the refrigerator, that is to say that it should be quite hard but should nevertheless spread well during baking so as to develop in a circular, square, rectangular, or bone-shaped form.

As a texturing agent, two whole eggs are added at a content of between about 10% and 20%, preferably at a content of about 15% to 18%.

In one embodiment, the dough, according to the invention, may also contain additional ingredients, such as CBD for pets with arthritis or other ailments. Further, the recipe can be altered for diabetic pets or for pets with other diseases and/or health issues, depending on the needs and/or wants of a user.

In one embodiment, the dough is packaged in a block already having the correct thickness in order to avoid having to further roll out the dough. To this effect, a block of dough is obtained which has a thickness of between about 1 and 3 cm.

In another embodiment, the dough is packaged in pre-cut shapes, such as circles, triangles, squares, rectangles, bone-shapes, etc., or any other suitable shape as is known in the art. In regard to pre-cut shapes, the triangle, square and rectangle pre-cut dough shapes are generally between about 2 and 4 cm in size and about 0.5 to 2 cm thick. The circular shaped pre-cut dough shapes typically have a diameter of between about 3 and 6 cm and a thickness of between about 0.5 and 2 cm. The specialty pre-cut shapes, such as bones, fish, carrots, etc., would typically have a thickness of between about 0.5 and 2 cm and are generally between about 2 and 4 cm in size.

In one embodiment, the dough can be any size and shape as is known in the art, and users can choose from small, medium, and large size treats. In another embodiment, small, medium, and large size treats are packaged together in one package having multiple size treats and a user can pick and choose which size to make when baking. In another embodiment, each package would only comprise one size treat to bake.

In one embodiment, the dough packaged in a block would have pre-cut grooves, these pre-cut grooves are not critical in regard to their sizes. The pre-cut grooves are normally provided which have a width of about 1 to 5 mm and an identical depth. In this embodiment, the user should either break the blocks like for a chocolate bar or use a knife to finish the cutting along the pre-cut grooves. Therefore, there is no waste associated with forming, and no manipulation, other than cutting, on the part of the user.

In one embodiment, the pre-mixed and pre-cut dough is positioned on an oven-safe and microwave-safe tray component and wrapped conventionally, for example in a wrapping based of synthetic material or based of a covered carton component, so as to be protected from air and moisture. The shelf life of the pre-mixed and pre-cut dough in a refrigerator is normally approximately several months. In another embodiment, the packaging component comprises a resealable wrapping component. The resealable wrapping component has a Ziplock securing means which allows the packaging component to be sealed and unsealed during use, or any other suitable securing means as is known in the art. The resealable wrapping component allows the unbaked dough to remain fresh longer within the refrigerator before being baked.

In one embodiment, the packaging component comprises an oven-safe and microwave-safe disposable tray component. Typically, the disposable tray component is rectangular or square-shaped, but can be any suitable shape as is known in the art. The disposable tray component comprises a lip or vertical wall around its perimeter to aid in retaining the pet treats on the tray component. The disposable tray component can be any suitable size and shape as is known in the art and can be larger in size when storing large sized pet treats and smaller in size when storing small sized pet treats.

The disposable tray component is oven-safe and microwave-safe, allowing a user to open the packaging component and place the tray component directly in an oven or microwave to bake. When done, the user can then dispose of the tray component. Typically, the tray component is manufactured of microwaveable plastics, polycarbonate, ceramic, etc., or any other suitable material as is known in the art, depending on the needs and/or wants of a user. Further, the tray component can comprise a temperature-resistant coating or other suitable coating to allow the tray component to be placed directly in an oven for baking.

In one embodiment, the disposable oven-safe tray component with the pre-cut dough is then placed in an oven and baked conventionally. Typically, the pre-cut dough is baked at a temperature of 180° C. for 12 to 18 minutes. In another embodiment, the disposable microwave-safe tray component with the pre-cut dough is then placed in a microwave and baked conventionally. Typically, the pre-cut dough is baked in the microwave for 3 to 5 minutes. In yet another embodiment, the pet treat system comprises a plurality of indicia.

In yet a further embodiment, a method of conveniently and easily baking a pre-packaged pet treat is disclosed. The method includes the steps of providing a packaging component that comprises a plurality of pre-mixed pet treats. The method also comprises positioning the plurality of pet treats on the disposable oven-safe and microwave-safe tray included with the packaging component, such that the pre-mixed pet treats do not touch. Further, the method comprises placing the oven-safe and microwave-safe tray into the oven or microwave to bake. Furthermore, baking the pet treats within the oven or microwave. Finally, feeding the baked pet treats to a user's pet.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the pet treat system of the present invention in accordance with the disclosed architecture;

FIG. 2 illustrates a perspective view of one embodiment of the pet treat system of the present invention disclosing the packaging component in accordance with the disclosed architecture;

FIG. 3 illustrates a perspective view of one embodiment of the pet treat system of the present invention wherein the pet treats are baked in a microwave in accordance with the disclosed architecture;

FIG. 4 illustrates a perspective view of one embodiment of the pet treat system of the present invention wherein the pet treats are baked in an oven in accordance with the disclosed architecture;

FIG. 5 illustrates a perspective view of one embodiment of the pet treat system of the present invention wherein a dog is fed a baked pet treat in accordance with the disclosed architecture; and

FIG. 6 illustrates a flowchart showing the method of conveniently and easily baking a pre-packaged pet treat in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a pet treat system that provides users with a pre-packaged pet treat which a user then bakes to make healthy, ready-to-eat treats for their pets. There is also a long-felt need in the art for a pet treat system that includes multiple different-sized treats, allowing pet owners to serve their pets a desired type of treat. Further, there is a long-felt need in the art for a pet treat system that features microwave and oven-safe trays for the pet treats, these trays are then used to bake the pre-made treats at home. Moreover, there is a long-felt need in the art for a system that utilizes resealable packaging to maintain the freshness of the treats for future feedings. Further, there is a long-felt need in the art for a pet treat system that offers multiple different size treats, allowing pet owners to serve their pets a desired type and size of treat. Finally, there is a long-felt need in the art for a pet treat system that allows users to be able to bake pet treats without needing to mix their own ingredients.

The present invention, in one exemplary embodiment, is a novel a pet treat system. The system comprises a special, pre-mixed dough made from a pet treat recipe. The recipe comprises at least flour, eggs, canned pumpkin, peanut butter, salt, cinnamon, and water, and can also comprise additional ingredients for making various flavored pet treats. Typically, the pre-mixed dough is formed into individual pet shapes and stored within a packaging component. The packaging component comprises a disposable oven-safe and microwave-safe tray that the pre-mixed dough is positioned on. Thus, allowing pet owners to bake the pet treats without needing to mix their own ingredients. The present invention also includes a novel method of conveniently and easily baking a pre-packaged pet treat. The method includes the steps of providing a packaging component that comprises a plurality of pre-mixed pet treats. The method also comprises positioning the plurality of pet treats on the disposable oven-safe and microwave-safe tray included with the packaging component, such that the pre-mixed pet treats do not touch. Further, the method comprises placing the oven-safe and microwave-safe tray into the oven or microwave to bake. Furthermore, baking the pet treats within the oven or microwave. Finally, feeding the baked pet treats to a user's pet.

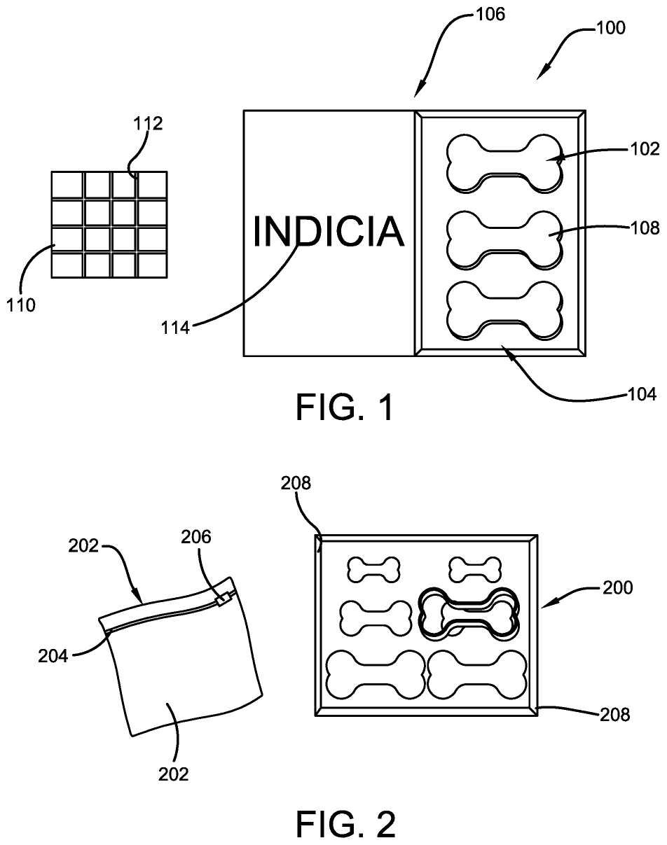

Referring initially to the drawings, FIG. 1 illustrates a perspective view of one embodiment of the pet treat system 100 of the present invention. In the present embodiment, the pet treat system 100 is an improved pet treat system that provides users with healthy, pre-packaged pet dough for making healthy pet treats for their pets. The pet treat system 100 comprises a special, pre-mixed dough 102 made from a pet treat recipe. The recipe comprises at least flour, eggs, canned pumpkin, peanut butter, salt, cinnamon, and water, and can also comprise additional ingredients for making various flavored pet treats 104. Typically, the pre-mixed dough 102 is formed into individual pet shapes and stored within a packaging component 106. Thus, pet owners can bake the pet treats 104 without needing to mix their own ingredients, creating healthy pet treats 104 with ease and convenience.

Further, the pet treat system 100 comprises a special, pre-mixed dough 102 secured within a packaging component 106. The special, pre-mixed dough 102 is a ready-for-use refrigerated dough for preparing pet treats 104. Typically, the dough 102 is prepared from flour, eggs, canned pumpkin, peanut butter, salt, cinnamon, and water. Additional ingredients can be incorporated based on the needs and/or wants of a pet, such as based on the medications, weight problems, eating issues, or other diseases or health issues the pet may have. The pre-mixed dough 102 is typically provided in a block form or separate, defined pieces of dough. The dough 102 is then placed in a microwave or oven and baked into pet treats 104 for use.

In the present description, the contents are given by weight. For example, the flour is present in an amount of 57%, the eggs in an amount of 18%, the canned pumpkin in an amount of 19%, the peanut butter in an amount of 4.5%, the salt in an amount of 0.5%, the ground cinnamon in an amount of 0.5%, and optional water in an amount of 0.8%.

The flour used is typically wholewheat flour which gives the baked products a denser and heavier texture. However, any type of flour can be utilized as is known in the art depending on the wants and/or needs of a user. The flour content is normally between about 50% and 60%, preferably between 55% and 57%.

In one embodiment, the dough 102 should have a good resistance during preservation in the refrigerator, that is to say that it should be quite hard but should nevertheless spread well during baking so as to develop in a circular, square, rectangular, or bone-shaped form once baked.

As a texturing agent, two whole eggs are added at a content of between about 10% and 20%, preferably at a content of about 15% to 18%.

In one embodiment, the dough 102, according to the invention, may also contain additional ingredients, such as CBD for pets with arthritis or other ailments. Further, the recipe can be altered for diabetic pets or for pets with other diseases and/or health issues, depending on the needs and/or wants of a user. Additionally, the recipe can be altered just to add different flavors and colors, depending on the needs and/or wants of a user.

Typically, the dough 102 is packaged in pre-cut shapes 108, such as circles, triangles, squares, rectangles, bone-shapes, etc., or any other suitable shape as is known in the art. In regard to pre-cut shapes 108, the triangle, square and rectangle pre-cut dough shapes are generally between about 2 and 4 cm in size and about 0.5 to 2 cm thick. The circular shaped pre-cut dough shapes typically have a diameter of between about 3 and 6 cm and a thickness of between about 0.5 and 2 cm. The specialty pre-cut shapes, such as bones, fish, carrots, etc., would typically have a thickness of between about 0.5 and 2 cm and are generally between about 2 and 4 cm in size. However, the pre-cut shapes 108 can be any suitable shape and size as is known in the art, depending on the needs and/or wants of a user.

Furthermore, the dough 102 can be any size and shape as is known in the art, and users can choose from small, medium, and large size treats 104. In one embodiment, small, medium, and large size treats 104 are packaged together in one package having multiple size treats and a user can pick and choose which size to make when baking. In another embodiment, each package would only comprise one size treat 104 to bake.

In another embodiment, the dough 102 is packaged in a block 110 already having the correct thickness in order to avoid having to further roll out the dough 102. To this effect, a block of dough 110 is obtained which has a thickness of between about 1 and 3 cm. Further, the dough 102 packaged in a block 110 would have pre-cut grooves 112, these pre-cut grooves 112 are not critical in regard to their sizes. The pre-cut grooves 112 are normally provided with a width of about 1 to 5 mm and an identical depth. In this embodiment, the user should either break the blocks 110 like for a chocolate bar or use a knife to finish the cutting along the pre-cut grooves 112.

Additionally, the pet treat system 100 comprises a plurality of indicia 114. The packaging component 106 of the system 100 may include advertising, a trademark, or other letters, designs, or characters, printed, painted, stamped, or integrated into the packaging component 106, or any other indicia 114 as is known in the art. Specifically, any suitable indicia 114 as is known in the art can be included, such as, but not limited to, patterns, logos, emblems, images, symbols, designs, letters, words, characters, animals, advertisements, brands, etc., that may or may not be pet or pet treats/brand related.

As shown in FIG. 2, the pre-mixed and pre-cut dough 102 is positioned on an oven-safe and microwave-safe tray component 200 and wrapped conventionally, for example in a wrapping component 202 based of synthetic material or based of a covered carton or paper wrapping, so as to be protected from air and moisture. The shelf life of the pre-mixed and pre-cut dough 102 in a refrigerator is normally approximately several months. In another embodiment, the packaging component 106 comprises a resealable wrapping component 204. The resealable wrapping component 204 has a Ziplock securing means 206 which allows the packaging component 106 to be sealed and unsealed during use, or any other suitable securing means as is known in the art. The resealable wrapping component 204 allows the unbaked dough 102 to remain fresh longer within the refrigerator before being baked.

As stated supra, the packaging component 106 comprises an oven-safe and microwave-safe disposable tray component 200. Typically, the disposable tray component 200 is rectangular or square-shaped, but can be any suitable shape as is known in the art. The disposable tray component 200 comprises a lip or vertical wall 208 around its perimeter to aid in retaining the pet treats 104 on the tray component 200. The disposable tray component 200 can be any suitable size and shape as is known in the art and can be larger in size when storing large size pet treats 104 and smaller in size when storing small size pet treats 104.

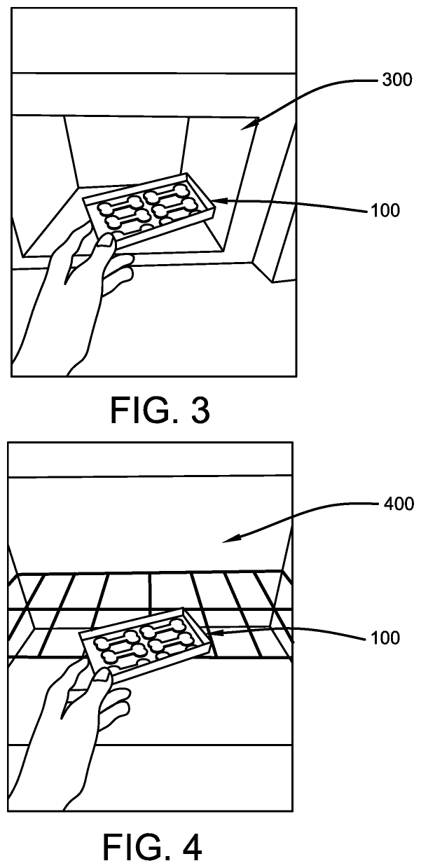

As shown in FIGS. 3-4, the disposable tray component 200 is oven-safe and microwave-safe, allowing a user to open the packaging component 106 and place the tray component 200 directly in an oven 400 or microwave 300 to bake. When done, the user can then dispose of the tray component 200. Typically, the tray component 200 is manufactured of microwaveable plastics, polycarbonate, ceramic, polypropylene or acrylonitrile-butadiene-styrene (ABS), or any other suitable material as is known in the art, such as, but not limited to, polyethylene terephthalate, polyvinyl chloride, polystyrene, etc. Generally, the tray component 200 comprises a temperature-resistant coating or other suitable coating to allow the tray component 200 to be placed directly in an oven 400 for baking.

As shown in FIG. 4, the disposable oven-safe tray component 200 with the pre-cut dough 102 is then placed in an oven 400 and baked conventionally. Typically, the pre-cut dough 102 is baked at a temperature of 180° C. for 12 to 18 minutes. In another embodiment as shown in FIG. 3, the disposable microwave-safe tray component 200 with the pre-cut dough 102 is then placed in a microwave 300 and baked conventionally. Typically, the pre-cut dough 102 is baked in the microwave 300 for 3 to 5 minutes.

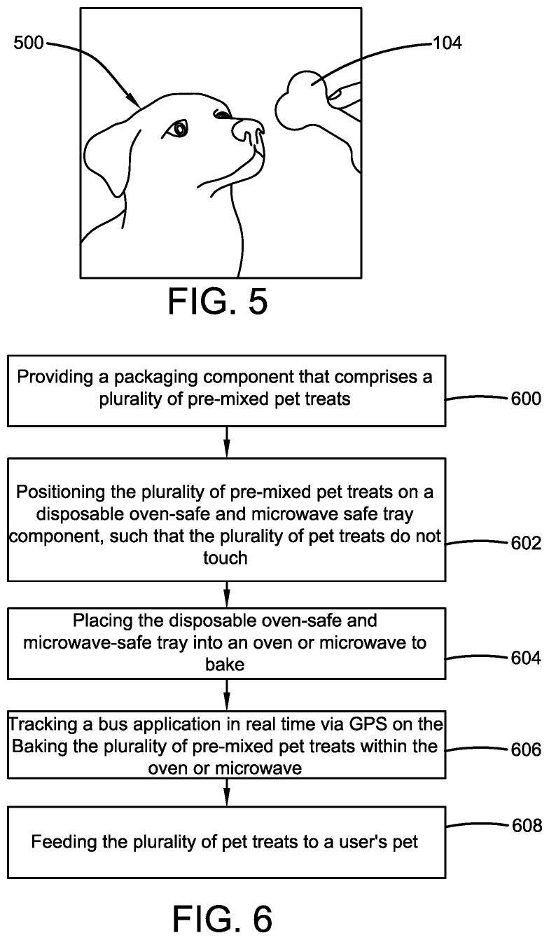

As shown in FIG. 5, after baking, the pet treats 104 are removed from the oven 400 or microwave 300 for use. A user slides the pet treats 104 off the disposable tray component 200 via a spatula or other suitable cooking utensil and disposes of the tray component 200 in a trash receptacle. A user can then immediately feed the pet treats 104 to a pet 500 or store them for later use in an airtight container (not shown).

FIG. 6 illustrates a flowchart of the method of conveniently and easily baking a pre-packaged pet treat. The method includes the steps of at 600, providing a packaging component that comprises a plurality of pre-mixed pet treats. The method also comprises at 602, positioning the plurality of pre-mixed pet treats on a disposable oven-safe and microwave-safe tray component included with the packaging component, such that the plurality of pre-mixed pet treats do not touch. Further, the method comprises at 604, placing the disposable oven-safe and microwave-safe tray component into the oven or microwave to bake. Furthermore, at 606, baking the plurality of pre-mixed pet treats within the oven or microwave. Finally, at 608, feeding the plurality of baked pre-mixed pet treats to a user's pet.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “pet treat system”, “treat system”, and “system” are interchangeable and refer to the pet treat system 100 of the present invention.

Notwithstanding the foregoing, the pet treat system 100 of the present invention can be of any suitable size and configuration as is known in the art without affecting the overall concept of the invention, provided that it accomplishes the above-stated objectives. One of ordinary skill in the art will appreciate that the pet treat system 100 as shown in FIGS. 1-6 are for illustrative purposes only, and that many other sizes and shapes of the pet treat system 100 are well within the scope of the present disclosure. Although the dimensions of the pet treat system 100 are important design parameters for user convenience, the pet treat system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pet treat system that provides users with healthy, pre-packaged pet dough for making pet treats, the pet treat system comprising:
a pre-mixed dough made from a pet treat recipe; and
a packaging component; and
wherein the pre-mixed dough is formed into pre-cut shapes and stored within the packaging component; and
further wherein a pet owner can bake a plurality of pet treats from the pre-mixed dough without needing to mix ingredients.

2. The pet treat system of claim 1, wherein the pre-mixed dough comprises at least flour, eggs, canned pumpkin, peanut butter, salt, cinnamon, and water.

3. The pet treat system of claim 2, wherein the flour is present in an amount of 57%, the eggs in an amount of 18%, the canned pumpkin in an amount of 19%, the peanut butter in an amount of 4.5%, the salt in an amount of 0.5%, the ground cinnamon in an amount of 0.5%, and optional water in an amount of 0.8% per weight.

4. The pet treat system of claim 3, wherein the pre-mixed dough further comprises CBD.

5. The pet treat system of claim 4, wherein the pre-cut shapes comprise at least one of circles, triangles, squares, rectangles, or bones.

6. The pet treat system of claim 5, wherein the pre-mixed dough is packaged in a block.

7. The pet treat system of claim 6, wherein the block comprises pre-cut grooves for separating the pre-mixed dough into pet treats to be baked.

8. The pet treat system of claim 7 further comprising a plurality of indicia.

9. The pet treat system of claim 8, wherein the packaging component comprises a disposable oven-safe and microwave-safe tray component for retaining the pre-mixed dough.

10. The pet treat system of claim 9, wherein the packaging component comprises a wrapping component for protecting the pre-mixed dough from air and moisture.

11. The pet treat system of claim 10, wherein the wrapping component is a resealable wrapping component.

12. The pet treat system of claim 11, wherein the resealable wrapping component comprises a Ziplock securing means.

13. A pet treat system that provides users with healthy, pre-packaged pet dough for making pet treats, the pet treat system comprising:
a pre-mixed dough made from at least flour, canned pumpkin, peanut butter, salt and water; and
a packaging component comprising a wrapping component and an oven-safe and microwave-safe tray component; and
wherein the pre-mixed dough is formed into pre-cut bone shapes and stored on the oven-safe and microwave-safe tray component within the wrapping component; and
further wherein pet owners can bake a plurality of pet treats from the pre-mixed dough without needing to mix ingredients.

14. The pet treat system of claim 13, wherein the oven-safe and microwave-safe tray component is disposable.

15. The pet treat system of claim 14, wherein the oven-safe and microwave-safe tray comprises a vertical wall around its perimeter.

16. The pet treat system of claim 13, wherein the wrapping component is a resealable wrapping component.

17. The pet treat system of claim 13, wherein the pre-mixed dough is packaged in a block with pre-cut grooves for separating the pre-mixed dough into pet treats to be baked.

18. The pet treat system of claim 13 wherein the pre-mixed dough further comprises CBD.

19. The pet treat system of claim 13 further comprising an egg and a ground cinnamon, wherein the flour is present in an amount of 57%, the egg in an amount of 18%, the canned pumpkin in an amount of 19%, the peanut butter in an amount of 4.5%, the salt in an amount of 0.5%, the ground cinnamon in an amount of 0.5%, and optional water in an amount of 0.8% per weight.

20. A method of conveniently and easily baking a pre-packaged pet treat, the method comprising the following steps:
providing a packaging component that comprises a plurality of pre-mixed pet treats;
positioning the plurality of pre-mixed pet treats on a disposable oven-safe and microwave-safe tray component included with the packaging component, such that the plurality of pre-mixed pet treats do not touch;
placing the disposable oven-safe and microwave-safe tray into an oven or microwave to bake;
baking the plurality of pre-mixed pet treats within the oven or microwave; and
feeding the plurality of baked pre-mixed pet treats to a user's pet.
